(19) United States
(12) Patent Application Publication
(10) Pub. No.: US 2015/0251384 A1
(43) Pub. Date: Sep. 10, 2015

(54) GLASS LAMINATES WITH NANOFILLED IONOMER INTERLAYERS

(71) Applicant: E.I.DU PONT DE NEMOURS AND COMPANY, Wilmington, DE (US)

(72) Inventors: Stephen J. Bennison, Wilmington, DE (US); Sam Louis Samuels, Landenberg, PA (US); Gordon Mark Cohen, Wynnewood, PA (US); Mark David Wetzel, Newark, DE (US)

(21) Appl. No.: 14/430,586

(22) PCT Filed: Oct. 11, 2013
(86) PCT No.: PCT/US13/64428

§ 371 Date: Mar. 24, 2015

Related U.S. Application Data
(60) Provisional application No. 61/713,021, filed on Oct. 12, 2012.

(30) Foreign Application Priority Data
Oct. 10, 2013 (US) PCT/US13/64207

(51) Int. Cl. B32B 17/10; B32B 37/10

(52) U.S. Cl. CPC B32B 17/10614; B32B 17/10018; B32B 17/10036; B32B 17/10743; B32B 37/1009; B32B 2315/08

(57) ABSTRACT

Provided herein are glass laminates having at least one glass layer and a nanofilled ionomeric interlayers comprising a nanofiller in a blend of a first ionomer and a second ionomer that is different from the first ionomer. The second ionomer is a water dispersable ionomer that allows for excellent dispersion of the nanofiller in the ionomer matrix. The laminates retain favorable performance properties such as high transparency while exhibiting lower creep or heat deflection.

This application claims priority from U.S. Provisional Patent Application Ser. No. 61/713,021, filed Oct. 12, 2012 and PCT Application Serial Number PCT/US13/64207, filed Oct. 10, 2013.

### FIELD OF THE INVENTION

The present invention is directed to glass laminates having nanofilled ionomeric interlayers.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

Glass laminates, or laminated glass, have been used commercially for almost a century. One type of glass laminate, safety glass, has been widely used in the automobile industry in windshields or side windows. These materials are characterized by high impact and penetration resistance. In addition, a particular advantage is that, when shattered, safety glass does not scatter glass shards and debris. More recently, glass laminates have also been incorporated into building structures as windows, walls and stairs.

A typical glass laminate consists of a sandwich of two glass sheets or panels bonded together by a thick polymeric interlayer sheet. In some applications, one of the glass sheets may be replaced with an optically clear rigid polymeric sheet, such as a polycarbonate sheet or a hardcoated polyester film. Safety laminates have further evolved to include multiple layers of glass and optionally also polymeric sheets or films bonded together by the polymeric interlayer sheets.

The interlayers used in glass laminates are typically made from relatively thick polymer sheets, which exhibit toughness and bondability to the glass in the event of a crack or crash. Widely used interlayer materials include complex, multicomponent compositions based on poly(vinyl butyral) (PVB), poly(urethane) (PU), poly(ethylene vinyl acetate) (EVA), partially neutralized poly(ethylene (meth)acrylic acid) (ionomers), and the like.

Ionomers are copolymers produced by partially or fully neutralizing the carboxylic acid groups of precursor or parent polymers that are acid copolymers comprising copolymerized residues of α-olefins and α,β-ethylenically unsaturated carboxylic acids. The use of ionomer compositions as interlayers in laminated safety glass is known in the art. See, e.g., U.S. Pat. Nos. 3,344,014; 3,762,988; 4,663,228; 4,668,574; 4,799,346; 5,759,698; 5,763,062; 5,895,721; 6,150,028; and 6,432,522, U.S. Patent Publications 2002/0155302; 2002/0155302; 2006/0182983; 2007/0092706; 2007/0122633; 2007/0289693; 2010/0227135, and PCT Patent Publications WO99/58334; WO2006/057771 and WO2007/149082.

Because ionomers are thermoplastic, the possibility of deformation, flow or creep of ionomers under high-temperature operating conditions has led to some limitations in use of ionomers in certain glass laminate applications. Laminates prepared from ionomers may have insufficient creep resistance for high temperature applications. A conventional method to increase stiffness and the heat deflection temperature (HDT) of thermoplastic materials has been to add glass fiber. Although increasing HDT, the addition of glass fiber increases weight, promotes poor surface appearance, molding difficulties and anisotropic properties such as shrinkage, decreases toughness and negatively impacts optical properties such as clarity and light transmission.

It is desirable to develop ionomer compositions with increased heat deflection temperature, increased stiffness/modulus at room temperature and elevated temperatures below the melting point of the ionomer, increased upper use temperature at a given stiffness and reduced long term creep at elevated temperatures while maintaining good optical properties.

### SUMMARY OF THE INVENTION

Provided herein is a glass laminate comprising at least one glass layer and an ionomeric interlayer sheet comprising a nanofilled ionomer composition comprising or consisting essentially of

(1) a first ionomer that is an ionic, neutralized derivative of a precursor α-olefin carboxylic acid copolymer, wherein about 10% to about 35% of the total content of the carboxylic acid groups present in the precursor α-olefin carboxylic acid copolymer is neutralized to form salts containing alkali metal cations, alkaline earth metal cations, transition metal cations, or combinations of two or more of these metal cations, and wherein the precursor α-olefin carboxylic acid copolymer comprises (i) copolymerized units of an α-olefin having 2 to 10 carbons and (ii) about 15 to about 25 weight %, based on the total weight of the precursor α-olefin carboxylic acid copolymer, of copolymerized units of an α,β-ethylenically unsaturated carboxylic acid having 3 to 8 carbons, wherein the ionomer has a melt flow rate (MFR) of about 0.1 g/10 min to about 60 g/10 min;

(2) at least one nanofiller; and

(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min., wherein MFR is measured according to ASTM D1238 at 190° C. with a 2.16 kg load.

### DETAILED DESCRIPTION OF THE INVENTION

The following definitions apply to the terms as used throughout this specification, unless otherwise limited in specific instances. Moreover, unless otherwise defined, all technical and scientific terms used herein have the same meaning as commonly understood by one of ordinary skill in the art to which this invention belongs. In case of conflict, the present specification, including the definitions herein, will control.

Although methods and materials similar or equivalent to those described herein can be used in the practice or testing of the invention, suitable methods and materials are described herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. Finally, all percentages, parts, ratios, and the like set forth herein are by weight, unless otherwise stated in specific instances.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise in limited circumstances. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Moreover, where a range of numerical values is recited herein, unless otherwise stated in specific circumstances, the range is intended to include the endpoints thereof, and all integers and fractions within the range. It is not intended that the scope of the invention be limited to the specific values recited when defining a range. Finally, when the term “about” is used in describing a value or an end-point of a range, the disclosure should be understood to include the specific value or end-point referred to.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

As used herein, the terms “comprises,” “comprising,” “includes,” “including,” “containing,” “characterized by,” “has,” “having” or any other synonym or variation thereof refer to a non-exclusive inclusion. For example, a process, method, article, or apparatus that is described as comprising a particular list of elements is not necessarily limited to those particularly listed elements but may further include other elements not expressly listed or inherent to such process, method, article, or apparatus.

The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format.”

Where an invention or a portion thereof is described with an open-ended term such as “comprising,” it is to be understood that, unless otherwise stated in specific circumstances, this description also includes a description of the invention using the term “consisting essentially of” as they are defined above.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof. In describing and/or claiming this invention, the term “copolymer” is used to refer to polymers formed by copolymerization of two or more monomers. Such copolymers include dipolymers, terpolymers or higher order copolymers.

The term “acid copolymer” refers to a polymer comprising copolymerized units of an α-olefin, an α,β-ethylenically unsaturated carboxylic acid, and optionally other suitable comonomer(s), such as an α,β-ethylenically unsaturated carboxylic acid ester.

The term “ionomer” refers to a polymer that is produced by partially or fully neutralizing an acid copolymer as described above. More specifically, the ionomer comprises ionic groups that are metal ion carboxylates, for example, alkali metal carboxylates, alkaline earth metal carboxylates, transition metal carboxylates and mixtures of such carboxylates. Such polymers are generally produced by partially or fully neutralizing the carboxylic acid groups of precursor or parent polymers that are acid copolymers, as defined herein, for example by reaction with a base. An example of an alkali metal ionomer as used herein is a sodium ionomer (or sodium neutralized ionomer), for example a copolymer of ethylene and methacrylic acid wherein all or a portion of the carboxylic acid groups of the copolymerized methacrylic acid units are in the form of sodium carboxylates.

The term “laminate”, as used herein alone or in combined form, such as “laminated” or “lamination” for example, refers to a structure having at least two layers that are adhered or bonded firmly to each other. The layers may be adhered to each other directly or indirectly. “Directly” means that there is no additional material, such as an interlayer or an adhesive layer, between the two layers, and “indirectly” means that there is additional material between the two layers.

The materials, methods, and examples herein are illustrative only and, except as specifically stated, are not intended to be limiting.

Provided herein is a glass laminate that comprises one or more glass sheets and one or more nanofilled ionomeric interlayer sheets. A representative glass laminate includes a nanofilled ionomeric interlayer sheet laminated between two glass sheets.

As used herein, the term “nanofiller” refers to inorganic materials, including without limitation solid allotropes and oxides of carbon, having a particle size of about 0.9 to about 200 nm in at least one dimension. The related terms “nanofilled” and “nanocomposite” refer to a composition that contains nanofiller dispersed in a polymer matrix. In particular, a nanofilled ionomer composition contains a nanofiller dispersed in a polymer matrix comprising an ionomer as defined above.

The term “dispersed”, as used herein with respect to a nanofiller in a polymer matrix, refers to a state in which the nanofiller particles are sufficiently small in size and sufficiently surrounded by the polymer matrix so that the optical clarity of the nanocomposite is not significantly compromised. In particular, the nanofiller is dispersed when the haze of the nanocomposite is less than 5% or the difference in Transmitted Solar Energy (τₛₑ) between the polymer matrix and the nanocomposite is less than 0.5%.

In general, nanofillers such as nanoclay particles are highly polar and prefer to associate with each other rather than a polymer that is of lower polarity, resulting in a poor dispersion. Surprisingly, the separated nanofiller particles that are dispersed in the ionomer as described herein do not re-agglomerate under melt processing conditions.

The invention provides glass laminates comprising or prepared from a nanofilled ionomer composition. The addition of certain nanoparticles to thermoplastic polymers has been shown to significantly increase low shear viscosity and to reduce flow. It has been found that the addition of these nanoparticles to ionomers provides thermoplastic ionomer compositions that are “creep resistant” while maintaining transparency.

A shaped article such as a sheet used in a glass laminate prepared from the nanofilled ionomer composition has a heat deflection temperature determined according to ASTM D-648 that exceeds that of a comparison standard article wherein the shaped article and the comparison standard article have the same shape and structure with the exception that the comparison standard article is prepared from an ionomer composition that does not comprise a nanofiller.

Measurement of the amount of movement (creep) of a test glass laminate after exposing the glass/thermoplastic interlayer/glass laminate to an elevated temperature for a specified amount of time can provide insights into relative creep performance of various materials in similar configurations, e.g. frameless glass-glass modules.

Laminates comprising ionomeric interlayers that were not modified by inclusion of nanofillers deformed significantly in creep measurement tests above 100° C., while laminates comprising nanofilled ionomer compositions as interlayers surprisingly showed little or no deformation after extended exposure to temperatures of 105° C. or 115° C.

The nanofilled ionomer compositions used herein contain ionomers that are ionic, neutralized derivatives of precursor acid copolymers. Examples of suitable ionomers are described in U.S. Pat. No. 7,763,360 and U.S. Patent Application Publication 2010/0112253, for example. Briefly, however, suitable precursor acid copolymers comprise copolymerized units of an α-olefin having 2 to 10 carbons and about 15 to about 30 weight % of copolymerized units of an α,β-ethylenically unsaturated carboxylic acid having 3 to 8 carbons, and 0 to about 40 weight % of other comonomers. The weight percentages are based on the total weight of the precursor acid copolymer. In addition, the amount of copolymerized α-olefin is complementary to the amount of copolymerized α,β-ethylenically unsaturated carboxylic acid and of other comonomer(s), if present, so that the sum of the weight percentages of the comonomers in the precursor acid copolymer is 100%.

Suitable α-olefin comonomers include, but are not limited to, ethylene, propylene, 1-butene, 1-pentene, 1-hexene, 1-heptene, 3 methyl-1-butene, 4-methyl-1-pentene, and the like and mixtures of two or more thereof. Preferably, the α-olefin is ethylene.

Suitable α,β-ethylenically unsaturated carboxylic acid comonomers include, but are not limited to, acrylic acids, methacrylic acids, itaconic acids, maleic acids, maleic anhydrides, fumaric acids, monomethyl maleic acids, and mixtures of two or more thereof. Preferably, the α,β-ethylenically unsaturated carboxylic acid is selected from acrylic acids, methacrylic acids, and mixtures thereof.

The precursor acid copolymers may further comprise copolymerized units of other comonomer(s), such as unsaturated carboxylic acids having 2 to 10, or preferably 3 to 8 carbons, or derivatives thereof. Suitable acid derivatives include acid anhydrides, amides, and esters. Esters are preferred. Specific examples of preferred esters of unsaturated carboxylic acids include, but are not limited to, those described in U.S. Patent Application Publication 2010/0112253. Examples of more preferred comonomers include, but are not limited to, alkyl (meth)acrylates such as methyl acrylate, methyl methacrylate, butyl acrylate, and butyl methacrylate; other (meth)acrylate esters, such as glycidyl methacrylates; vinyl acetates, and mixtures of two or more thereof. Alkyl acrylates are still more preferred. The precursor acid copolymers may comprise 0 to about 40 weight % of other comonomers; such as about 5 to about 25 weight %. The presence of other comonomers is optional, however, and in some articles it is preferable that the precursor acid copolymer not include any other comonomer(s).

The α-olefin or the α,β-ethylenically unsaturated carboxylic acid of the second precursor acid copolymer may, independently, be the same as or different from the α-olefin or the α,β-ethylenically unsaturated carboxylic acid of the first precursor acid copolymer. Likewise, the amount of copolymerized units of the α-olefin or of the α,β-ethylenically unsaturated carboxylic acid of the second precursor acid copolymer may, independently, be the same as or different from the amount of copolymerized units of the α-olefin or of the α,β-ethylenically unsaturated carboxylic acid of the first precursor acid copolymer.

The precursor acid copolymers may be polymerized as disclosed in U.S. Pat. Nos. 3,404,134; 5,028,674; 6,500,888; 6,518,365; 7,763,360 and U.S. Patent Application Publication 2010/0112253. Preferably, the precursor acid copolymers are polymerized under process conditions such that short chain and long chain branching is maximized. Such processes are disclosed in, e.g., P. Ehrlich and G. A. Mortimer, “Fundamentals of Free-Radical Polymerization of Ethylene”, Adv. Polymer Sci., Vol. 7, p. 386-448 (1970) and J. C. Woodley and P. Ehrlich, “The Free Radical, High Pressure Polymerization of Ethylene II. The Evidence For Side Reactions from Polymer Structure and Number Average Molecular Weights”, J. Am. Chem. Soc., Vol. 85, p. 1580-1854. High levels of branching are associated with favorable properties such as reduced crystallinity, which leads to better clarity.

The precursor α-olefin carboxylic acid copolymer of the first ionomer may comprise about 18 to about 25 weight %, preferably about 18 to about 23 weight %, such as about 18 to about 20 weight % or about 21 to about 23 weight %, of copolymerized units of the α,βethylenically unsaturated carboxylic acid and the precursor α-olefin carboxylic acid copolymer may have a melt flow rate of about 100 g/10 min or less, preferably about 30 g/10 min or less. Preferably, the α-olefin is ethylene. Preferably, the carboxylic acid is acrylic acid or methacrylic acid.

To obtain the first and second ionomers useful in the ionomer compositions described herein, the precursor acid copolymers are neutralized with a base so that the carboxylic acid groups in the precursor acid copolymer react to form carboxylate groups. Preferably, the precursor acid copolymers are neutralized to a level of about 10 to about 70%, such as from 10 to about 35, or about 50 to about 70%, based on the total carboxylic acid content of the precursor acid copolymers as calculated or as measured for the non-neutralized precursor acid copolymers.

Any stable cation and any combination of two or more stable cations are believed to be suitable as counterions to the carboxylate groups in the first and second ionomers. For example, divalent and monovalent cations, such as cations of alkali metals (such as sodium or potassium), alkaline earth metals (such as magnesium), and some transition metals (such as zinc), may be used.

To obtain (e.g. sodium or zinc neutralized) ionomers useful in the nanofilled ionomer compositions, the precursor acid copolymers of the first ionomer are neutralized with for example a sodium or zinc-containing base to provide an ionomer wherein at least a portion of the hydrogen atoms of carboxylic acid groups of the precursor acid copolymer are replaced by metal cations. Preferably, for the first ionomer about 10% to about 35%, or about 15% to about 30% of the hydrogen atoms of carboxylic acid groups of the precursor acid are replaced by metal cations. That is, the acid groups are neutralized to a level of about 10% to about 35%, based on the total carboxylic acid content of the precursor acid copolymers as calculated or measured for the non-neutralized precursor acid copolymers. Likewise the second ionomer may be neutralized to a level of 50 to 70% by using sodium and/or potassium-containing bases. The preferred neutralization ranges make it possible to obtain an article with the desirable end use properties that are novel characteristics of the nanofilled ionomer compositions described herein, such as low haze, high clarity, sufficient impact resistance and low creep, while still maintaining melt flow that is sufficiently high so that the ionomer can be processed or formed into articles. The precursor acid copolymers may be neutralized as disclosed, for example, in U.S. Pat. No. 3,404,134.

Unless indicated otherwise, melt flow rate (MFR) was determined in accordance with ASTM method D1238 at 190° C. and 2.16 kg. The precursor acid copolymer may have a MFR of about 0.1 g/10 min or about 0.7 g/10 min to about 30 g/10 min, about 45 g/10 min, about 55 g/10 min, or about 60 g/10 min, or about 100 g/10 min. After neutralization, the MFR of the ionomer may be from about 0.1 to about 60 g/10 min., such as about 1.5 to about 30 g/10 min. The ionomer therefrom may have a melt flow rate of about 30 g/10 min or less, preferably about 5 g/10 min or less.

Of note are precursor acid copolymers having a melt flow rate (MFR) of about 30 g/10 min or less. After neutralization, the MFR can be less than 5 grams/10 min, and possibly less than 2.5 g/10 min or less than 1.5 g/10 min. Suitable ionomers made by neutralizing these precursor acid copolymers with a sodium-containing base have a MFR of about 2 g/10 min or less. Of note are ionomers wherein (i) the precursor α-olefin carboxylic acid copolymer has a MFR of about 30 g/10 min or less; (ii) the precursor α-olefin carboxylic copolymer comprises about 21 to about 23 weight % of copolymerized units of the α,β-ethylenically unsaturated carboxylic acid; (iii) about 20% to about 35% of total content of the carboxylic acid groups present in the precursor α-olefin carboxylic have been neutralized with alkali metal ions; and (iv) the ionomer has a MFR of about 5 g/10 min or less.

Also of note are precursor acid copolymers having a melt flow rate (MFR) of about 100 g/10 min or less, such as about 60 g/10 min. Suitable ionomers made by neutralizing these precursor acid copolymers with a zinc-containing base have a MFR of about 30 g/10 min or less, such as about 3 to about 27 g/10 min. Of note are ionomers wherein (i) the precursor α-olefin carboxylic acid copolymer has a MFR of about 60 g/10 min or less; (ii) the precursor α-olefin carboxylic copolymer comprises about 18 to about 20 weight % of copolymerized units of the α,β-ethylenically unsaturated carboxylic acid; (iii) about 10% to about 15% of total content of the carboxylic acid groups present in the precursor α-olefin carboxylic have been neutralized with alkali metal ions; and (iv) the ionomer has a MFR of about 25 g/10 min or less.

The ionomers may also preferably have a flexural modulus greater than about 40,000 psi (276 MPa), more preferably greater than about 50,000 psi (345 MPa), and most preferably greater than about 60,000 psi (414 MPa), as determined in accordance with ASTM method D638. Ionomers described above do not readily disperse in water.

Some examples of suitable sodium ionomers useful as the first ionomer are also disclosed in U.S. Patent Application Publication 2006/0182983.

The second ionomer comprises a water dispersable ionomer comprising or consisting essentially of an ionomer derived from a parent acid copolymer that comprises copolymerized units of ethylene and about 18 to about 30 weight % of copolymerized units of acrylic acid or methacrylic acid, based on the total weight of the parent acid copolymer. The parent acid copolymer has a melt flow rate (MFR) from about 200 to about 1000 g/10 min, measured according to ASTM D1238 at 190° C. with a 2.16 kg load. About 50% to about 70% of the carboxylic acid groups of the parent acid copolymer, based on the total carboxylic acid content of the parent acid copolymer as calculated for the non-neutralized parent acid copolymer, are neutralized to form the water dispersible ionomer, which includes carboxylic acid salts comprising sodium cations, potassium cations or a combination of sodium cations and potassium cations. The resulting water dispersable ionomer has a MFR from about 1 to about 20 g/10 min.

As discussed further below, the water dispersable ionomer is useful in providing a nanofilled ionomer composition in which the nanofiller is well-dispersed in the ionomer matrix.

The neutralization levels of two ionomers in a blend may equilibrate over time to a shared neutralization level that is determined by the total number of acid and base equivalents in the ionomer blend. The second ionomer has a MFR, at the neutralization level of the ionomer blend, that is different from the MFR of the first ionomer at the same neutralization level.

The nanofilled ionomer compositions further contain a nanofiller. The nanofiller may be present at a level of about 3 to about 70 weight %, based on the total weight of the nanofilled ionomer composition, preferably from about 3 to about 20 weight %, more preferably from about 5 to about 12 weight %.

Suitable nanofillers are described in the patent application entitled “IONOMER COMPOSITE,” filed concurrently herewith (PCT Application Serial Number PCT/US13/64207, filed Oct. 10, 2013) and incorporated herein by reference. Briefly, however, the nanofillers or nanomaterials suitable for use as the second component of the nanofilled ionomer composition typically have a particle size of from about 0.9 to about 200 nm in at least one dimension, preferably from about 0.9 to about 100 nm. The shape and aspect ratio of the nanofiller may vary, including forms such as plates, rods, or spheres.

The average particle size of layered silicates can be measured, for example using optical microscopy, transmission electron spectroscopy (TEM), or atomic force microscopy (AFM).

Preferred nanofillers for creep resistance include rodlike, platy and layered nanofillers. The nanofillers may be naturally occurring or synthetic materials. In one embodiment, the nanofillers are selected from nano-sized silicas, nanoclays, and carbon nanofibers. Exemplary nano-sized silicas include, but are not limited to, fumed silica, colloidal silica, fused silica, and silicates. Exemplary nanoclays include, but are not limited to, smectite (e.g., aluminum silicate smectite), hectorite, fluorohectorite, montmorillonite (e.g., sodium montmorillonite, magnesium montmorillonite, and calcium montmorillonite), bentonite, beidelite, saponite, stevensite, sauconite, nontronite, and illite. Of note is sepiolite, which is rod-shaped and imparts favorable thermal and mechanical properties. The carbon nanofibers used here may be single-walled nanotubes (SWNT) or multi-walled nanotubes (MWNT). Suitable carbon nanofibers are commercially available, such as those produced by Applied Sciences, Inc. (Cedarville, Ohio) under the tradename Pyrograf™. Nanofillers may also be produced from hydromica or sericite.

As used herein, “aspect ratio” is the square root of the product of the lateral dimensions (area) of a platelet filler particle divided by the thickness of the platelet. Platelets with aspect ratio greater than 25, such as greater than 50, greater than 1,000 or greater than 5,000, are considered herein to have a “high aspect ratio”. Since there will be a distribution of different particles in a sampling of nanofiller, aspect ratio as used herein is based on the average of the primary exfoliated individual particles in the distribution. An exfoliated nanofiller may likely have residual tactoids that may be several primary platelets thick (e.g. 10-20 nanometers thick), compared to an individual particle that may be about 1 nm thick.

“Effective aspect ratio” relates to the behavior of the platelet filler in a binder. Platelets in a binder may not exist in a single platelet formation. If the platelets are not in a single layer in the binder, the aspect ratio of an entire bundle, aggregate or agglomerate of platelet fillers in a binder is less than that of the individual platelet. Additional discussion of these terms may be found in U.S. Pat. No. 6,232,389.

Nanofillers that are layered silicates or “phyllosilicates” are of particular note. Preferably, the layered silicates are obtained from micas or clays or from a combination of micas and clays. Preferred layered silicates include, without limitation, pyrophillite, talc, muscovite, phlogopite, lepidolithe, zinnwaldite, margarite, hydromuscovite, hydrophlogopite, sericite, montmorillonite, nontronite, hectorite, saponite, vermiculite, sudoite, pennine, klinochlor, kaolinite, dickite, nakrite, antigorite, halloysite, allophone, palygorskite, and synthetic clays such as Laponite™ and the like that are derived from hectorite, clays that are related to hectorite, or talc. More preferably, the layered silicates are obtained from hectorite, fluorohectorite, pyrophillite, muscovite, phlogopite, lepidolithe, zinnwaldite, hydromuscovite, hydrophlogopite, sericite, montmorillonite, vermiculite, kaolinite, dickite, nakrite, antigorite or halloysite. Still more preferably, the layered silicates are materials based on or derived from hectorite, muscovite, phlogopite, pyrophyllite and zinnwaldite, for example synthetic layered silicates, hydrous sodium lithium magnesium silicates, and hydrous sodium lithium magnesium fluorosilicates based on hectorite. Also of particular note are muscovite and synthetic clays that are based on muscovite. The nanofiller clays may optionally further comprise ionic fluorine, covalently bound fluorine, other cations aside from those in the natural clays, or sodium pyrophosphate.

More preferred layered silicates include synthetic hectorites such as Laponite™ synthetic layered silicate, available from Rockwood Additives (Southern Clay Products, Gonzales, Tex.). One such nanofiller, marketed under the tradename Laponite™ OG, is a Type 2 sodium magnesium silicate with a cation exchange capacity of about 60 meq/100 g and platelets about 83 nm long and 1 nm thick. More generally, preferred synthetic hectorites, such as Laponite™, have a particle size that is at least 50 nm in its largest dimension, or more preferably about 80 to about 100 nm. The average aspect ratio of the preferred synthetic hectorites is about 80 to about 100, although aspect ratios of about 300 may also be suitable. Clays, including synthetic hectorites, may be characterized by their cation exchange capacity. The preferred synthetic hectorites have a cation exchange capacity that is preferably less than 80 meq/100 g, more preferably less than 70 meq/100 g, and still more preferably less than 65 meq/100 g. Moreover, preferred synthetic hectorites have a low content of fluorine, preferably with less than 1 weight %, more preferably less than 0.1 weight %, and still more preferably less than 0.01 weight %, based on the total weight of the synthetic hectorite.

The surface of the layered silicates may be treated with surfactants or dispersants. Often, no such treatment is necessary or desirable. Preferably, when a surface treatment is used, the dispersant or surfactant does not comprise quaternary ammonium ions. These materials may degrade under processing conditions, lending an undesired color to the interlayer sheet. Tetrasodium pyrophosphate (TSPP) is a notable dispersant, however. When used as a surface treatment for layered silicates, the amount of TSPP is 15 weight % or less, preferably 10 weight % or less, more preferably 7 weight % or less, based on the total weight of the layered silicate.

Preferably, the nanofiller particles are comminuted, disintegrated or exfoliated to thin plate-like particles by suitable methods such as calcining or milling “Exfoliation” is the separation of individual layers of the platelet particles and the initial close-range order within the phyllosilicates is lost in this exfoliation process. The filler material used is at least partially exfoliated (at least some particles are separated into a single layer) and preferably is substantially exfoliated (the majority of the particles are separated into a single layer).

These processes produce smaller, thinner particles with higher aspect ratios. The smaller particles produce a clearer nanocomposite with increased enhancement of the desirable mechanical properties. The neat (“dry”) nanoparticles may be exfoliated, or preferably the nanoparticles may be exfoliated in a suspension, such as a suspension in water, in another polar solvent, in oil, or in any combination of two or more suspension media. The comminution, disintegration, or exfoliation may be performed by any mechanical or thermal method, or by a combination of thermal and mechanical methods, for example using a stirrer, a sonicator, a homogenizer, or a rotor-stator. Preferably, the nanofiller is a layered silicate that is thoroughly exfoliated (i.e., de-layered or split) to form individual nanoparticles or small aggregates of a few nanoparticles in each.

In many embodiments, the layered silicates do not have any significant coloring tone. Also notable are layered silicates that do not have a coloring tone that is discernible to the naked eye and layered silicates that do not have a coloring tone that influences the color of the polymer matrix significantly. Preferably, the layered silicates are thoroughly comminuted, disintegrated or exfoliated from the form in which they are supplied.

For layered silicate nanofillers, the mean thickness of an individual platelet is about 1 nm and the mean length or width is in the range of about 25 nm to about 500 nm. For Laponite™ which is smaller and has a lower aspect ratio, the mean length or width is preferably from about 40 nm to about 200 nm, and more preferably from about 75 to about 110 nm. The clay particles preferably show an average aspect ratio in the range of from about 10 to about 8000, from about 30 to about 2000 or from about 50 to about 500, and more preferably the average aspect ratio is about 30 to about 150. It is preferred that the clays used in the composition be able to hydrate to form gels or sols. Transparent, colorless clays are preferred, as they minimize adverse effects on the performance of articles comprising the composition, including clarity and transparency.

The use of interlayers that are nanofilled ionomeric materials, as described herein, will enhance the upper end-use temperature of the glass laminates that include these materials, because the nanofilled ionomeric materials also have reduced creep at elevated temperatures. The end-use temperature of the laminates may be enhanced by up to about 20° C. to about 70° C., or by a greater amount. Also advantageously, because the nanofilled ionomer compositions remain thermoplastic, the materials described herein have improved recyclability with respect to other interlayer materials that exhibit low creep because they have been crosslinked. Moreover, because of their small particle size, nanofillers will not significantly affect the optical properties of the interlayer sheets.

For example, the nanofillers effectively reduce the melt flow of the ionomer composition, while still allowing production of thermoplastic films or sheets. In addition, laminates having an interlayer that comprises nanofilled ionomeric materials will be more fire resistant than laminates having a conventional ionomeric interlayer. The reason is that the nanofilled ionomeric polymers have a reduced tendency to flow out of the laminate, which in turn, could reduce the available fuel in a fire situation.

Suitable methods for the synthesis of ionomer nanocomposites are described in detail in the abovementioned concurrently filed patent application (PCT Application Serial Number PCT/US13/64207) and in U.S. Pat. No. 7,759,414. Briefly, however, in the field of nanocomposites, attaining a homogeneous composite, i.e., a high degree of nanoparticle dispersion within the polymer matrix, is essential for achieving target performance. It is known that certain neat nanoparticles may be added directly to a neat ionomer, then dispersed and deagglomerated, preferably using a high-shear melt mixing process. It is also known for a relatively high amount of nanofiller to be dispersed in a relatively small amount of polymer to form a “masterbatch” which is subsequently diluted with a polymer matrix that may be the same as or different from the polymer in the masterbatch.

A preferred concentrated nanofiller masterbatch composition comprises (a) a water dispersable ionomer (as described above) and (b) a nanofiller. An aqueous dispersion of the water dispersable ionomer can be prepared by mixing the solid ionomer under low shear conditions with water heated to a temperature of from about 80 to about 90° C. Additional information regarding suitable water dispersable ionomers and the preparation of suitable aqueous ionomer dispersions is disclosed in U.S. Patent Application Publication 2013/0059972. The aqueous ionomer dispersion can be mixed with the nanofiller, also under low shear conditions at about 80 to about 90° C., followed by evaporation of the water to provide a solid ionomer/nanofiller masterbatch.

The concentrated nanofiller masterbatch may comprise about 10 to about 95 weight %, about 20 to about 90 weight %, about 30 to about 90 weight %, about 40 to about 75 weight %, or about 50 to about 60 weight % of the water dispersable ionomer and about 5 to about 70 weight %, about 10 to about 70 weight %, about 20 to about 70 weight %, about 25 to about 60 weight %, or about 30 to about 50 weight % of the nanofiller, based on the total weight of the masterbatch composition.

One preferred method for preparing the concentrated nanofiller masterbatch is a solvent process comprising the steps of (a) dispersing the nanofiller in a selected solvent such as water, optionally using a dispersant or surfactant; (b) dissolving a solid water dispersable ionomer in the same solvent system; (c) combining the solution and the dispersion; and (d) removing the solvent.

In another preferred process for preparing a concentrated nanofiller masterbatch, pellets or powder of a solid water dispersable ionomer and nanofiller powder are metered into the first feed port of an extruder. The solid mixture is conveyed to the extruder's melting zone, where the ionomer is melted by mechanical energy input from the rotating screws and heat transfer from the barrel, and where high stresses break down the nanofiller agglomerate particles. Liquid water (typically deionized) is pumped into the melted mixture, for example under pressure through an injection port in the extruder. The melted mixture is conveyed to a region of the extruder that is open to the atmosphere or under vacuum pressure, where some or all of the water evaporates or diffuses out of the mixture. This evaporation or diffusion step may optionally be repeated once or more. The resulting viscous polymer melt with well dispersed nanoparticles is removed from the extrudate; for example, it may be pumped by the screws and extruded through a shaping die. Should further processing under high-shear melt-mixing conditions be required to improve the dispersion quality, the extruded material may optionally be fed to the extruder and reprocessed, again optionally with water injection and removal.

The concentrated nanofiller masterbatch can be blended with the ionomer that forms the bulk of the polymeric matrix to produce the nanofilled ionomeric material. These nanocomposite compositions may be prepared using a melt process, which includes combining all the components of the nanofilled ionomeric composition, including the masterbatch, the bulk ionomer and additional optional additives, if any. These components are melt compounded at a temperature of about 130° C. to about 230° C., or about 170° C. to about 210° C., to form a uniform, homogeneous blend. The process may be carried out using stirrers, Banbury™ type mixers, Brabender PlastiCorder™ type mixers, Haake™ type mixers, extruders, or other suitable equipment.

Methods for recovering the homogeneous ionomeric nanocomposite produced by melt compounding will depend on the particular piece of melt compounding apparatus utilized and may be determined by those skilled in the art. For example, if the melt compounding step takes place in a mixer such as a Brabender PlastiCorder™ mixer, the homogeneous nanocomposite may be recovered from the mixer as a single mass. If the melt compounding step takes place in an extruder, the homogeneous nanocomposite will be recovered after it exits the extruder die in a form (sheet, filament, pellets, etc.) that is determined by the shape of the die and any post-extrusion processing (such as embossing, cutting, or calendaring, e.g.) that may be applied.

Accordingly, a suitable process for preparing the nanofilled ionomer composition comprises
(1) mixing a solid water dispersable ionomer composition comprising a water dispersible ionomer, as described above, with water heated to a temperature of from about 80 to about 90° C. to provide a heated aqueous ionomer dispersion;
(2) optionally cooling the aqueous ionomer dispersion;
(3) mixing the aqueous ionomer dispersion with one or more nanofillers to provide an aqueous dispersion of ionomer and nanofiller;
(4) removing the water from the aqueous dispersion of ionomer and nanofiller to provide a mixture of water dispersable ionomer and nanofiller in solid form;
(5) melt blending the mixture of water dispersable ionomer and nanofiller with another ionomer that is described above as suitable for use in the nanofilled ionomeric composition, specifically an ionomer that is an ionic, neutralized derivative of a precursor α-olefin carboxylic acid copolymer, wherein about 1% to about 100% or preferably about 10% to about 35% of the total content of the carboxylic acid groups present in the precursor α-olefin carboxylic acid copolymer is neutralized to form salts containing alkali metal cations, alkaline earth metal cations, transition metal cations, or combinations of two or more of these metal cations, and wherein the precursor α-olefin carboxylic acid copolymer comprises (i) copolymerized units of an α-olefin having 2 to 10 carbons and (ii) about 15 to about 25 weight %, based on the total weight of the precursor α-olefin carboxylic acid copolymer, of copolymerized units of an α,β-ethylenically unsaturated carboxylic acid having 3 to 8 carbons, wherein the ionomer has a melt flow rate (MFR) of about 0.1 g/10 min to about 60 g/10 min, as determined in accordance with ASTM method D1238 at 190° C. and 2.16 kg load.

Another suitable process for preparing the nanofilled ionomer composition comprises forming a concentrated nanofiller masterbatch in an extruder using water and a solid water dispersable ionomer, as described above; optionally removing the concentrated nanofiller masterbatch from the equipment, cooling it and forming it into a convenient shape, such as pellets; and melt blending the concentrated nanofiller masterbatch with another ionomer that is described above as suitable for use in the nanofilled ionomeric composition, such as the ionomer described immediately above with respect to the aqueous dispersion process.

Accordingly, preferred nanofilled ionomer compositions for use in the glass laminates comprise:

(1) a first ionomer that is

(a) an alkali metal ionomer that is an ionic, neutralized derivative of an ethylene carboxylic acid copolymer, wherein about 10% to about 35% of the total content of the carboxylic acid groups present in the precursor ethylene carboxylic acid copolymer are neutralized with alkali metal ions such as sodium, potassium or combinations thereof, and wherein the precursor ethylene carboxylic acid copolymer comprises (i) copolymerized units of ethylene and (ii) about 20 to about 25 weight %, based on the total weight of the ethylene carboxylic acid copolymer, of copolymerized units of an α,β-ethylenically unsaturated carboxylic acid having 3 to 8 carbons; having a melt flow rate (MFR) of about 2.5 g/10 min or less; or

(b) an ionic, neutralized derivative of an ethylene carboxylic acid copolymer, wherein about 10% to about 35%, such as about 10 to about 15%, of the total content of the carboxylic acid groups present in the precursor ethylene carboxylic acid copolymer are neutralized with zinc ions, and wherein the precursor ethylene carboxylic acid copolymer comprises (i) copolymerized units of ethylene and (ii) about 18 to about 20 weight %, based on the total weight of the ethylene carboxylic acid copolymer, of copolymerized units of an α,β-ethylenically unsaturated carboxylic acid having 3 to 8 carbons; having a melt flow rate (MFR) of about 30 g/10 min or less, such as about 3 to about 27 g/10 min;

(2) at least one nanofiller; and

(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min. measured according to ASTM D1238 at 190° C. with a 2.16 kg load.

The extent of dispersion of the nanofiller in the polymer matrix can be measured by X-ray diffraction. For example, X-ray diffraction (XRD) is commonly used to determine the interlayer spacing (d-spacing) of silicate layers in silicate-containing nanocomposites. When X-rays are scattered from the silicate platelets, peaks of the scattered intensity are observed corresponding to the clay structure. Based on Bragg's law, the interlayer spacing, i.e., the distance between two adjacent clay platelets, can be determined from the peak position of the XRD pattern. When interaction of nanoclay and polymer matrix occurs, and the polymer is inserted between the layers of clay, the interlayer spacing increases, and the reflection peak of the XRD pattern moves to a lower 2-THETA position. Under such conditions, the nanoclay is considered to be intercalated.

The masterbatch and the nanofilled ionomer composition may also contain other additives known in the art. Suitable additives include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, dispersants, surfactants, chelating agents, coupling agents, and the like. Four notable additives are thermal stabilizers, UV absorbers, hindered amine light stabilizers (HALS), and silane coupling agents. Suitable and preferred examples of these additives and suitable and preferred levels of these additives are set forth in U.S. Patent Application Publication 2010/0112253.

Further, the ionomeric interlayer sheet may have a total thickness of about 1 to about 120 mils (about 0.025 to about 3 mm), or about 5 to about 100 mils (about 0.127 to about 2.54 mm), or about 5 to about 45 mils (about 0.127 to about 1.14 mm), or about 10 to about 35 mils (about 0.25 to about 0.89 mm), or about 10 to about 30 mils (about 0.25 to about 0.76 mm). When a glass laminate includes more than one ionomeric interlayer sheet, the thickness of each of the sheets is independently selected.

The ionomeric interlayer sheet may have a smooth or rough surface on one or both sides prior to the lamination process used to prepare the glass laminate. In one laminate, the sheet has rough surfaces on both sides to facilitate de-airing during the lamination process. Rough surfaces can be created by mechanically embossing or by melt fracture during extrusion of the sheets followed by quenching so that surface roughness is retained during handling. The surface pattern can be applied to the sheet through common art processes. For example, the as-extruded sheet may be passed over a specially prepared surface of a die roll positioned in close proximity to the exit of the die which imparts the desired surface characteristics to one side of the molten polymer. Thus, when the surface of such a die roll has minute peaks and valleys, the polymer sheet cast thereon will have a rough surface on the side that is in contact with the roll, and the rough surface generally conforms respectively to the valleys and peaks of the roll surface. Such die rolls are described in, e.g., U.S. Pat. No. 4,035,549 and U.S. Patent Publication 2003/0124296.

The ionomeric interlayer sheets can be produced by any suitable process. For example, the sheets may be formed through dipcoating, solution casting, compression molding, injection molding, lamination, melt extrusion casting, blown film extrusion, extrusion coating, tandem extrusion coating, or by any other procedures that are known to those of skill in the art. Preferably, the sheets are formed by an extrusion method, such as melt extrusion casting, melt coextrusion casting, melt extrusion coating, or tandem melt extrusion coating processes.

Notable glass laminates include those wherein the ionomeric interlayer sheet has a first side and a second side, and wherein the first side is bonded directly to a glass sheet.

In one laminate, the glass sheets are derived from any suitable conventional glass sheets with a thickness of about 2 mm or more. The glass sheets may include, but are not limited to, window glass, plate glass, silicate glass, sheet glass, low iron glass, tempered glass, tempered CeO-free glass, and float glass, but also colored glass, specialty glass (such as those containing ingredients to control solar heating), coated glass (such as those sputtered with metals (e.g., silver or indium tin oxide) for solar control purposes), low E-glass, Toroglas® glass (Saint-Gobain N.A. Inc., Trumbauersville, Pa.), Solexia™ glass (PPG Industries, Pittsburgh, Pa.), and Starphire® glass (PPG Industries).

Thin glass sheets may be selected from any suitable types of glass sheets, such as block or rolled thin glass sheets. The term “thin glass sheet” as used herein refers to a glass sheet or film having a thickness of less than 2.0 mm, or about 1.9 mm or less, or about 1.8 mm or less, or about 1.7 mm or less, or about 1.6 mm or less, or about 1.5 mm or less, or about 1.2 mm or less, or about 1 mm or less, or about 0.8 mm or less, or about 0.1 to about 0.8 mm, or about 0.2 to about 0.7 mm, or about 0.3 to about 0.7 mm, or about 0.4 to about 0.7 mm, or about 0.5 to about 0.7 mm. Some types of thin glass sheets have been used as substrates in liquid crystal devices and are commercially available from, e.g., Praezisions Glas & Optik GmbH (Germany), Pilkington (Toledo, Ohio), Matsunami Glass Ind., Ltd. (Japan), Nippon Sheet Glass Company, Ltd. (Japan), Nippon Electric Glass Co., Ltd. (Japan), and Asahi Glass Co., Ltd. (Japan).

In addition to one or more glass sheets and one or more nanofilled ionomeric interlayer sheets, the glass laminates may further comprise additional films, rigid sheets, or other non-ionomeric polymeric interlayer sheets.

Suitable additional films include without limitation metal films such as aluminum foil, and polymeric films. Suitable polymeric film materials include but are not limited to polyesters (e.g., poly(ethylene terephthalate) and poly(ethylene naphthalate)), polycarbonates, polyolefins (e.g., polypropylene, polyethylene, and cyclic polyloefins), norbomene polymers, polystyrenes (e.g., syndiotactic polystyrene), styrene-acrylate copolymers, acrylonitrile-styrene copolymers, polysulfones (e.g., polyethersulfone, and polysulfone), polyamides, polyurethanes, acrylic polymers, cellulose acetates (e.g., cellulose acetate and cellulose triacetates), cellophanes, vinyl chloride polymers (e.g., poly(vinyl chloride) and poly(vinylidene chloride)), fluoropolymers (e.g., poly(vinyl fluoride), poly(vinylidene fluoride), polytetrafluoroethylene, and ethylene-tetrafluoroethylene copolymers), and combinations of two or more of these materials.

When a polymeric film is incorporated as an outside surface layer of the glass laminate, the outside surface may be provided with an abrasion resistant hard coat. Any material known for use in abrasion resistant hardcoats may be used. For example, the hardcoat may comprise polysiloxanes or cross-linked (thermosetting) polyurethanes. Also suitable are oligomeric-based coatings, such as those described in U.S. Patent Application Publication 2005/0077002, which are prepared by the reaction of (A) a hydroxyl-containing oligomer with isocyanate-containing oligomer or (B) an anhydride-containing oligomer with epoxide-containing compound. In certain laminates, the hard coat may comprise a polysiloxane abrasion resistant coating, such as those described in U.S. Pat. Nos. 4,177,315; 4,469,743; 5,415,942; and 5,763,089.

A further laminate may include rigid sheets other than glass. Suitable rigid sheets comprise a material with a tensile modulus of about 690 MPa or higher as determined in accordance with ASTM D-638. The other rigid sheets may be formed of metal, ceramic, or polymers selected from polycarbonates, acrylics, polyacrylates, cyclic polyolefins, metallocene-catalyzed polystyrenes, and combinations of two or more thereof.

The additional polymeric interlayer sheets may be formed of any suitable polymeric material, such as poly(vinyl acetal) (e.g., poly(vinyl butyral)), poly(vinyl chloride), polyurethanes, poly(ethylene vinyl acetate), ethylene acid copolymers, or combinations of two or more of these materials. Blends and combinations of these materials with the ionomers described above are also suitable.

By “laminated”, it is meant that, within a laminated structure, the two layers are bonded either directly (i.e., without any additional material between the two layers) or indirectly (i.e., with additional material, such as interlayer or adhesive materials, between the two layers). Accordingly, the nanofilled ionomeric interlayer sheet may be directly bonded to the glass sheet, or, it may be bonded to the glass sheet by way of one or more layers of adhesive or primer materials.

Another glass laminate further comprises an additional film or rigid sheet, such as those described above, laminated to the other side (or to a second side) of the nanofilled ionomeric interlayer sheet. The glass laminate may comprise a glass sheet, which is laminated to the nanofilled ionomeric interlayer sheet, which is further laminated to a second glass sheet. The laminates may comprise a conventional glass sheet with a thickness of about 2 mm or more. Alternatively, the glass laminate may comprise at least one thin glass sheet with a thickness of 2.0 mm or less, or preferably of about 1.5 mm or less, which is laminated to a nanofilled ionomeric interlayer sheet, which is further laminated to second glass sheet, preferably with a thickness of 2.0 mm or less, or preferably of about 1.5 mm or less. Also, the glass laminate may comprise a thin glass sheet with a thickness of 2.0 mm or less, or preferably of about 1.5 mm or less, which is laminated to an nanofilled ionomeric interlayer sheet, which is further laminated to a polymeric film, such as a polyester (e.g., poly(ethylene terephthalate)) film, and wherein the polymeric film may have a layer of hardcoat applied to its outside surface.

In another laminate, the ionomeric interlayer sheet has a first side that is laminated to the thin glass sheet. The glass laminate further comprises a rigid sheet laminated to a second side of the ionomeric interlayer sheet. The rigid sheet is preferably a second glass sheet having a thickness of about 2 mm or more. Alternatively, the rigid sheet comprises a polymeric material.

In another laminate, the glass laminate may comprise n layers of films and/or rigid sheets and n−1 layers of polymeric interlayer sheets, wherein (i) n is an integer of 2 to 10; (ii) each adjacent pair of the films and/or rigid sheets are interspaced by one of the polymer interlayer sheets; and (iii) one or more of the n layers of the films and/or rigid sheets are formed of the thin glass sheets described above; and (iv) one or more of the n−1 layers of the polymeric interlayer sheets comprise the ionomer composition described above.

In yet another laminate, the glass laminate may comprise n layers of the thin glass sheets as described above and n−1 layers of the ionomeric interlayer sheets, as described above, wherein (i) n is an integer of 2 to 10; (ii) each of the n layers of thin glass sheets independently has a thickness of about 1.5 mm or less, and (iii) each adjacent pair of the thin glass sheets are interspaced by one of the ionomeric interlayer sheets.

Any suitable lamination process may be used to prepare the glass laminate described herein. First, if desired, one or both surfaces of any of the component layers of the glass laminate may undergo any suitable adhesion enhancing treatment prior to the lamination process. Suitable adhesion treatments are described in the reference texts cited above and in U.S. Pat. No. 7,625,627 with respect to the polymeric film, for example.

Laminating the assembly in autoclave process comprises
(a) stacking the component layers of the glass laminate in the desired order to form a pre-lamination assembly;
(b) placing the assembly into a structure capable of sustaining a vacuum;
(c) drawing the air is drawn out of the vacuum structure to form a vacuum;
(d) maintaining the vacuum and processing the pre-lamination assembly at a pressure of about 150 to about 250 psi, and at a temperature of about 110° C. to about 180° C.

In the autoclave process, the component layers of a glass laminate such as at least one glass layer and the nanofilled ionomer interlayer are stacked up in the desired order to form a pre-lamination assembly. The assembly is then placed into a structure capable of sustaining a vacuum such as a bag (“a vacuum bag”). A vacuum ring may be substituted for the vacuum bag. One type of suitable vacuum bag is described in U.S. Pat. No. 3,311,517. The air is drawn out of the vacuum bag using a vacuum line or other means, the bag is sealed while the vacuum is maintained (e.g., at about 27 to 28 in Hg (689-711 mm Hg)), and the sealed bag is placed in an autoclave. The sealed bag containing the assembly is processed in the autoclave at a pressure of about 150 to about 250 psi (about 11.3 to 18.8 bar), and at a temperature of about 110° C. to about 180° C., or about 120° C. to about 160° C., or about 135° C. to about 160° C., for about 10 to about 90 min, or about 20 to about 70 min, or about 25 to about 60 min. Following the heat and pressure cycle, the air in the autoclave is cooled without adding additional gas; thus, the pressure inside the autoclave is allowed to decrease. After about 20 min of cooling, the autoclave is vented to the atmosphere and the sealed bag containing the laminate is removed from the autoclave.

Alternatively, the pre-lamination assembly may be heated in an oven at about 80° C. to about 120° C., or about 90° C. to about 100° C., for about 20 to about 40 min. Thereafter, the heated assembly is passed through a set of nip rolls so that the air in the void spaces between the individual layers may be expelled and the edge of the assembly may be sealed. The assembly at this stage is referred to as a pre-press assembly.

The pre-press assembly may then be placed in an air autoclave and processed at a temperature of from about 120° C. to about 160° C., or about 135° C. to about 160° C., and at a pressure of about 100 to about 300 psi (about 6.9 to about 20.7 bar), or about 200 psi (13.8 bar). These conditions may be maintained for about 15 to about 60 min, or about 20 to about 50 min. Following the heat and pressure cycle, the air in the autoclave is cooled without adding additional gas. After about 20 to about 40 min of cooling, the excess air pressure is vented and the laminated products are removed from the autoclave.

The glass laminate may also be produced via non-autoclave processes. Such non-autoclave processes are described, for example, in U.S. Pat. Nos. 3,234,062; 3,852,136; 4,341,576; 4,385,951; 4,398,979; 5,536,347; 5,853,516; 6,342,116; and 5,415,909, U.S. Patent Publication 2004/0182493, European Patent EP1235683 B1, and PCT Patent Publications WO91/01880 and WO03/057478. Generally, the non-autoclave processes include heating the pre-lamination assembly and the application of vacuum, pressure or both. For example, the assembly may be successively passed through heating ovens and nip rolls.

The glass laminates may further comprise mounting devices to attach the glass laminates to additional components in a glass laminate assembly. Any suitable material may be used in forming the mounting device(s). More specifically, the mounting device may be fabricated from any material(s) that are sufficiently durable to withstand the stress of supporting the glass laminate. In addition, the mounting device is also capable of withstanding any additional forces that may be applied to the glass laminate, such as for example the force of wind on a window, or the force of a pressure difference between the interior and exterior of an automobile or a building. Accordingly, the at least one mounting device may be made of a sufficiently tough metal, such as steel, aluminum, titanium, brass, lead, chrome, copper, or combinations or alloys of two or more of these metals. Alternatively, the at least one mounting device may be made of a sufficiently tough plastic, such as polycarbonate, polyurethane, nylon, or a combination of two or more of these plastics.

The glass laminate may further comprise an anchoring means used to fix the laminate to support structures. Any type of anchoring means that can be used to fix the laminate to support structures can be used. For example, the anchoring means may be a hole in the mounting device, which can be used to receive a screw to fix the laminate onto a support structure. Other suitable anchoring means include, without limitation, means similar to screws, such as nails and bolts. Anchoring means that do not require a hole include a clamp or similar device that secures the laminate to the frame via the mounting device. A clamp may be secured to the frame or to the mounting device; therefore, it may “clamp” the frame, or it may “clamp” the mounting device.

In addition, mounting devices may be tabs or coupons having a size that is small relative to the length of the edges of the laminate. Other configurations are possible, however, including mounting devices that are closer in length to the length of the edges of the laminate. Longer mounting devices may be equipped with a plurality of anchoring means. Additional discussion of mounting devices and anchoring means may be found in U.S. Patent Application Publication 2010/0227135, incorporated herein by reference.

The glass laminates described herein may be useful in a number of industries, such as construction, automotive, aerospace, and marine. For example, they can be used as glazings in buildings, automobiles, airplanes, and ships.

The invention is further illustrated by the following examples of certain embodiments.

### EXAMPLES

The following Examples are intended to be illustrative of the invention, and are not intended in any way to limit the scope of the invention.

### Material and Methods

Ionomers: The ethylene/methacrylic acid dipolymers listed in Table 1 were neutralized to the indicated extent by treatment with NaOH, zinc oxide or KOH using standard procedures to form sodium, zinc or potassium-containing ionomers. Melt flow rates (MFR) were determined in accordance with ASTM D1238 at 190° C. with a 2.16 kg mass. ION-1 and ION-3 are ionomers that are not readily water dispersable. ION-2 is a water dispersable ionomer.

TABLE 1

| Precursor Copolymer | | | | | |
|---|---|---|---|---|---|
| Methacrylic | | Ionomer | | | |
| acid, | MFR | | | Neutralization | MFR |
| weight %* | g/10 min | | Cation | Level % | g/10 min |
| 21.7 | 23 | ION-1 | Na⁺ | 26 | 1.8 |
| 19 | 330 | ION-2 | K⁺ | 50 | 4.5 |
| 19 | | ION-3 | Zn⁺² | 11-12 | 25 |

*remainder ethylene

Nanofiller NF-1: a Type 2 sodium magnesium silicate with a cation exchange capacity (CEC) of about 60 meq/100 g and platelets about 83 nm long and 1 nm thick, commercially available from Rockwood Additives (Southern Clay Products, Gonzales, Tex.) under the tradename Laponite™ OG.
Additive UVS-1: a UV-stabilizer commercially available from BASF under the tradename Tinuvin™ 328.

### General Sheeting Process for Preparing Extruded Interlayer Sheets

Pellets of ionomer were fed into a 25 mm diameter Killion extruder using the general temperature profile set forth in Table 2.

TABLE 2

| Extruder Zone | Temperature (° C.) |
|---|---|
| Feed | Ambient |
| Zone 1 | 100-170 |
| Zone 2 | 150-210 |
| Zone 3 | 170-230 |
| Adapter | 170-230 |
| Die | 170-230 |

The polymer throughput was controlled by adjusting the screw speed. The extruder fed a 150 mm slot die with a nominal gap of 2 to 5 mm. The cast sheet was fed onto a 200 mm diameter polished chrome chill roll held at a temperature of between 10° C. and 15° C. rotating at 1 to 2 rpm.

### Comparative Example Interlayer Sheet C1

UVS-1 (0.12 weight % based on the amount of polymer) was added to ION-1 in a single screw extruder operating at about 230° C. The resulting mixture was cast into a sheet for subsequent lamination as detailed below. The sheet measured about 0.9 mm thick.

### General Procedure for Preparing Aqueous Dispersions

A round-bottom flask equipped with a mechanical stirrer, a heating mantle, and a temperature probe associated with a temperature controller for the heating mantle was charged with water. The water was stirred and the neat solid ionomer ION-2 was added to the water at room temperature. The aqueous ionomer mixture was stirred at room temperature for 5 minutes and then heated to 80° C. Next, the mixture was stirred for 20 min at 90° C. until the ionomer was fully incorporated into the water, as judged by the clarity of the mixture. The heating mantle and temperature controller were removed from the round-bottom flask, and the aqueous ionomer mixture was cooled to room temperature with continued stirring.

Nanofiller was added as a powder to the aqueous ionomer mixture. During the addition, the aqueous ionomer mixture was stirred rapidly so that the nanofiller was incorporated smoothly without forming dry lumps. Stirring was continued for approximately 30 min until the nanofiller was dispersed, again as judged by the clarity of the mixture.

The aqueous ionomer mixture, with or without dispersed nanofiller, was dried before further use. The round bottom flask was attached to a rotary evaporator to which a house vacuum of about 100 mmHg was applied. The flask was immersed in a water bath at 65° C. and rotated slowly while the temperature bath was gradually raised to a maximum of 85° C. The rotary evaporation under heat and vacuum were continued for one to two days. The solid product was removed from the round bottom flask and further dried for about 16 to 64 hours in an oven at 50° C. under house vacuum (about 120 to 250 mm Hg) with a slowly flowing nitrogen atmosphere.

### Ionomer A

An aqueous dispersion of ION-2 was prepared and dried according to the general aqueous dispersion procedure above, in quantities shown in Table 3. There was no filler in this material.

### Ionomer B

An aqueous dispersion of ION-2 was prepared, mixed with filler NF-1 and dried according to the general aqueous dispersion procedure above, in quantities shown in Table 3.

TABLE 3

| | Ionomer A | Ionomer B |
|---|---|---|
| Deionized water, g | 165.0 | 165.0 |
| ION-2, g | 49.05 | 11.55 |
| NF-1, g | 0 | 4.95 |
| Calculated weight % of NF-1 in dried solids | 0 | 30 |

### General Procedure for Preparing Ionomer Blends

A Brabender PlastiCorder™ Model PL2000 mixer (available from Brabender Instruments Inc. of South Hackensack, N.J.) with Type 6 mixing head and stainless roller blades was heated to 140° C. and mixed at the same temperature. A portion of a solid ionomer (15 g of Ionomer A or of Ionomer B) was melt-blended in the mixer with 30.0 g of ION-1. The materials were mixed at 140° C. for 20 minutes at 75 rpm under a nitrogen blanket delivered through the ram. The blend was removed from the mixer and allowed to cool to room temperature. The two blends are summarized in Table 4. A blend comprising ION-3 and 10 weight % of nanofiller is prepared using a similar procedure by substituting ION-3 for ION-1, blended with Ionomer B.

TABLE 4

| | Comparative Example C2 | Example 1 |
|---|---|---|
| Ionomer A (g) | 15 | 0 |
| Ionomer B (g) | 0 | 15 |
| ION-1 (g) | 30 | 30 |
| Calculated weight % of NF-1 | 0 | 10 |

### Comparative Example C2 Interlayer Sheet

Two films were formed by molding the blend of Comparative Example C2 (see Table 4) in a hydraulic press at 190° C., incrementally raising the pressure to 152 MPa, and holding the temperature and pressure for 210 seconds, followed by cooling the platens to around 37° C. and removing the resultant films from the mold. The cooled films measured about 0.8 mm thick.

### Example 1

### Interlayer Sheet

Two films were formed by molding the composition of Example 1 (see Table 4) in a hydraulic press at 215° C., incrementally raising the pressure to 152 MPa, and holding the temperature and pressure for 210 seconds, followed by cooling to around 37° C. and removing the resultant films from the mold. Cooled films measured about 0.8 mm thick.

### Glass Laminates

In order to assess the suitability of nanocomposites in solar cell modules, glass laminates were prepared by the Lamination Process described below, using the films of Comparative Examples C1 and C2 and Example 1 to prepare two glass/interlayer/glass laminates from each of the three interlayer sheets.

Each glass/interlayer/glass laminate comprised a 102 mm×102 mm film of the interlayers described above, a 102 mm×204 mm×3 mm (rectangular) bottom glass plate and a 102 mm×102 mm×3 mm (square) top glass plate and were laminated as follows. The glass plates were high clarity, low iron Diamant® float glass from Saint Gobain Glass. Pre-laminates were laid-up with the interlayer film and the square glass plate coinciding and offset about 25 mm from one of the short edges of the rectangular glass plate. The “tin side” of each glass plate was in contact with the interlayer sheet. These specimens were laminated in a Meier vacuum laminator at 150° C. using a 5-minute evacuation, 1-minute press, 15-minute hold and 30-second pressure release cycle, using nominal “full” vacuum (0 mBar) and 800 mBar pressure.

### Creep Test

The glass laminates were tested for heat deformation or “creep.” Each laminate was hung from the top rack of an air oven by the 25-mm exposed edge of the larger glass plate using binder clips. The oven was preheated to 105° C. or to 115° C. The other end of the larger glass plate rested on a catch pan to prevent the laminate from slipping out of the binder clips. With this mounting system, the rectangular glass plate was constrained in a vertical position while the interlayer and square glass plate were unsupported and unconstrained. The vertical displacement of the smaller glass plates was measured periodically and reported in Table 5.

TABLE 5
Vertical Displacement in mm

| | | | |
|---|---|---|---|
| | Comparative | | |
| Time (hours) | Example C1 | Comparative Example C2 | Example 1 |

T = 105° C.

| | | | |
|---|---|---|---|
| 2.5 | 0 | 0 | 0 |
| 6 | 0 | 0 | 0 |
| 24 | 2 | 2 | 0 |
| 48 | 6 | 5 | 0 |
| 120 | 8 | 7 | 0 |
| 168 | 10 | 9 | 0 |
| 200 | 12 | 10 | 0 |

T = 115° C.

| | | | |
|---|---|---|---|
| 2.5 | 0 | 0 | 0 |
| 6 | 1 | 1 | 0 |
| 24 | 4 | 4 | 0 |
| 48 | 8 | 7 | 0 |
| 120 | 19 | 15 | 0 |
| 168 | 27 | 19 | 0 |
| 200 | 32 | 21 | 0 |

The results in Table 5 show that Comparative Examples C1 and C2 exhibited significant vertical displacement during the heat treatment. This vertical displacement is a measurement of creep. In contrast, the nanofilled composition (Example 1) exhibited no measureable vertical displacement throughout the duration of the tests. This result indicates that the nanofilled composition has very low creep or excellent creep resistance.

### Preparation of ION-2/NF-1 Masterbatch MB2 by Melt Extrusion

A ZSK-18 mm intermeshing, co-rotating twin-screw extruder (Coperion Corporation of Ramsey, N.J.) with 41 Length/Diameter (L/D) was used to make a an ION-2/NF-1 composite concentrate masterbatch using a melt extrusion process with water injection and removal. A conventional screw configuration was used containing a solid transport zone to convey pellets and clay powder from the first feed port, a melting section consisting of a combination of kneading blocks and several reverse pumping elements to create a seal to minimize water vapor escape, a melt conveying and liquid injection region, an intensive mixing section consisting of several combinations kneading block, gear mixer and reverse pumping elements to promote dispersion, distribution and polymer dissolution and water diffusion, one melt degassing and water removal zone and a melt pumping section. The melt was extruded through a die to form strands that were quenched in water at room temperature and cut into pellets. Polymer pellets and solid powders were metered into the extruder separately using loss in weight feeders (KTron Corp., Pitman, N.J.). Deionized (de-mineralized) water was injected into the extruder downstream of the melting zone using a positive displacement pump (Teledyne ISCO 500D, Lincoln, Nebr.). No attempt to exclude oxygen from the extruder was made. One vacuum vent zone was used to extract a portion of the water, volatile gases and entrapped air. Barrel temperatures, after the unheated feed barrel section, were set in a range from 160 to 185° C. depending on heat transfer and thermal requirements for melting, liquid injection, mixing, water removal and extrusion through the die. The throughput was fixed at 10 lb/hr and the screw rotational speed was 500 rpm. The deionized water injection flow rate was set to approximately 30 mL/minute. The extruded masterbatch pellets were then fed into the extruder for a second pass at a throughput of 10 lb/hr, a screw speed of 525 rpm, and a water injection flow rate of 16 ml/minute. A masterbatch with NF-1 silicate concentration of 25 weight % was produced. No organic surface modifiers were used on the NF-1 or added during the extrusion process.

### General Procedure for Preparing Ionomer Blends by Extrusion Melt Blending

A ZSK-18 mm intermeshing, co-rotating twin-screw extruder (Coperion Corp.) with 41 Length/Diameter (L/D) was used to melt and mix masterbatch MB2 described immediately above with ION-1 matrix polymer. A conventional screw configuration was used containing a solid transport zone to convey pellets from the first feed port, a melting section consisting of a combination of kneading blocks and one or more reverse pumping elements, a melt conveying region, a distributive mixing section consisting of several combinations of kneading block, gear mixer and reverse pumping elements, one melt degassing zone and a melt pumping section. Host (matrix) polymer and masterbatch pellets were metered into the extruder separately using two loss-in-weight feeders (KTron Corp.). No attempt to exclude oxygen from the extruder was made. For these samples, barrel temperatures were set in a range from 150 to 180° C. depending on heat transfer and thermal requirements for melting, mixing and extrusion through the die. The melt was then extruded through a die to form strands that were quenched in water at room temperature and cut into pellets. The throughput was fixed at 12 lb/hr and the screw rotational speed was 350 rpm. Extruded pellet samples were dried in conventional pellet drying equipment at 60 to 65° C. to reduce the moisture level below 1000 ppm. Pellet samples were packaged in metal lined, vacuum sealed bags. The compositions of the blends thus produced are summarized in Table 6. Similar blends comprising ION-3 and 5 or 10 weight % of nanofiller are prepared using a similar procedure by substituting ION-3 for ION-1.

TABLE 6

| | Comparative Example C3 | Example 2 | Example 3 |
|---|---|---|---|
| ION-2 (weight %) | 30 | 15 | 30 |
| NF-1 (weight %) | 0 | 5 | 10 |
| ION-1 (weight %) | 70 | 80 | 60 |

Four films of each composition in Table 6 were prepared using the procedure described for Comparative Example C1 above. The films were used to prepare glass/interlayer/glass laminates according to the general procedure described above. After lamination the interlayer in each laminate was about 33 to 34 mils thick in a total laminate thickness of about 264 to 279 mils thick.

### Solar Energy Transmittance Testing

The glass laminates were thoroughly cleaned using Windex® glass cleaner and lintless cloths to ensure that they were substantially free of dirt and other contaminants that might otherwise interfere with making valid optical measurements. The transmission spectrum of each laminate was then determined using a Varian Cary 5000 UV/VIS/NIR spectrophotometer (version 1.12) equipped with a DRA-2500 diffuse reflectance accessory, scanning from 2500 nm to 200 nm, with UV-VIS data interval of 1 nm and UV-VIS-NIR scan rate of 0.200 seconds/nm, utilizing full slit height and operating in double beam mode. The DRA-2500 is a 150 mm integrating sphere coated with Spectralon™. A total transmittance spectrum was obtained for each laminate and used to calculate Total Solar Energy Transmittance (τₛₑ) over the range of wavelengths from 1100 to 300 nm according to the method described in DIN EN 410. The results are summarized in Table 7. Solar energy transmittance is an indicator of the total solar energy that would be transmitted through the laminate to a photovoltaic cell.

TABLE 7

| Laminate | Solar Energy Transmittance (%) |
|---|---|
| Comparative Example C3 | 88.24 |
| Example 2 | 88.27 |
| Example 3 | 87.80 |

The data in Table 7 show that solar energy transmittance was not significantly affected by the inclusion of 5 to 10 weight % of nanofiller.

### Creep Test

The glass laminates were tested for creep performance according to the general procedure described above and the results as the average of eight measurements (four measurements of each laminate, two laminates of each interlayer) are summarized in Table 8.

TABLE 8
Vertical Displacement in mm

| | | | |
|---|---|---|---|
| Time (hours) | Comparative Example C3 | Example 2 | Example 3 |

T = 105° C.

| | | | |
|---|---|---|---|
| 2.5 | 0 | 0 | 0 |
| 8 | 1.7 | 0.4 | 0 |
| 24 | 4 | 1.7 | 0 |
| 48 | 8 | 2.7 | 0 |
| 120 | 18.6 | 4 | 0 |
| 144 | 23 | 4.4 | 0 |
| 200 | 33 | 5.6 | 0.2 |

T = 115° C.

| | | | |
|---|---|---|---|
| 2 | 0.7 | 0 | 0 |
| 6 | 2.3 | 0.6 | 0 |
| 24 | 9.5 | 2.5 | 0 |
| 48 | 20.4 | 4.1 | 0 |
| 120 | 58.9 | 8.0 | 0.7 |
| 168 | 76* | 9.9 | 0.8 |
| 200 | 76* | 10.9 | 0.9 |

*Maximum displacement possible in this test assembly

The results in Table 8 show that Comparative Example C3 exhibited significant creep during the thermal exposure. In contrast, the nanofilled compositions (Examples 2 and 3) exhibited superior creep resistance throughout the duration of the tests. Example 3, in which the ionomeric interlayer sheet contained 10 weight % of nanofiller, provided excellent creep resistance.

Heat deflection temperature (HDT) may be determined for the compositions at 264 psi (1.8 MPa) according to ASTM D648.

While certain of the preferred embodiments of the present invention have been described and specifically exemplified above, it is not intended that the invention be limited to such embodiments. It is to be understood, moreover, that even though numerous characteristics and advantages of this invention have been set forth in the foregoing description, together with details of the structure and function of the invention, the disclosure is illustrative only, and changes may be made in detail, especially in matters of shape, size and arrangement of parts, within the principles of the invention to the full extent indicated by the broad general meaning of the terms in which the appended claims are expressed.

1-16. (canceled)

17. A glass laminate comprising at least one glass layer and an ionomeric interlayer sheet comprising a nanofilled ionomer composition comprising
(1) a first ionomer that is an ionic, neutralized derivative of a precursor α-olefin carboxylic acid copolymer, wherein about 10% to about 35% of the total content of the carboxylic acid groups present in the precursor α-olefin carboxylic acid copolymer is neutralized to form salts containing alkali metal cations, alkaline earth metal cations, transition metal cations, or combinations of two or more of these metal cations, and wherein the precursor α-olefin carboxylic acid copolymer comprises (i) copolymerized units of an α-olefin having 2 to 10 carbons and (ii) about 15 to about 25 weight %, based on the total weight of the precursor α-olefin carboxylic acid copolymer, of copolymerized units of an α,β-ethylenically unsaturated carboxylic acid having 3 to 8 carbons, wherein the ionomer has a melt flow rate (MFR) of about 0.1 g/10 min to about 60 g/10 min;
(2) at least one nanofiller; and
(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min;
wherein MFR is measured according to ASTM D1238 at 190° C. with a 2.16 kg load.

18. The glass laminate of claim 17, wherein the precursor α-olefin carboxylic acid copolymer comprises about 18 to about 25 weight % of copolymerized units of the α,β-ethylenically unsaturated carboxylic acid and wherein the precursor α-olefin carboxylic acid copolymer has a melt flow rate of about 100 g/10 min or less and the ionomer has a melt flow rate of about 30 g/10 min or less.

19. The glass laminate of claim 18, wherein the precursor α-olefin carboxylic acid copolymer comprises about 18 to about 23 weight % of copolymerized units of the α,β-ethylenically unsaturated carboxylic acid.

20. The glass laminate of claim 18, wherein the precursor α-olefin carboxylic acid copolymer has a melt flow rate of about 30 g/10 min or less- and the ionomer has a melt flow rate of about 5 g/10 min or less.

21. The glass laminate of claim 18, wherein the ionomer has a flexural modulus greater than about 40,000 psi (276 MPa), as determined in accordance with ASTM D638.

22. The glass laminate of claim 17 wherein the nanofiller is present at a level of about 3 to about 70 weight % based on the total weight of the nanofilled ionomer composition and comprises a nano-sized silica, a nanoclay, or carbon nanofibers and has a particle size of about 0.9 to about 200 nm.

23. The glass laminate of claim 22 wherein the nano-sized silica comprises fumed silica, colloidal silica, fused silica, silicate, or mixtures of two or more thereof.

24. The glass laminate of claim 22 wherein the nanoclay comprises smectite, hectorite, fluorohectorite, montmorillonite, bentonite, beidelite, saponite, stevensite, sauconite, nontronite, illite, synthetic nanoclay, modified nanoclay, or mixtures of two or more thereof.

25. The glass laminate of claim 22 wherein the average aspect ratio of the nanofiller is about 30 to about 150.

26. The glass laminate of claim 22 wherein the nanofiller is a synthetic hectorite that is a Type 2 sodium magnesium silicate having a cation exchange capacity of about 60 meq/100 g, a platelet form, and a particle size of at least 50 nm in its largest dimension and about 1 nm thick.

27. The glass laminate of claim 17 wherein the ionomeric interlayer sheet has a thickness of about 0.025 to about 3 mm.

28. The glass laminate of claim 27 wherein the ionomeric interlayer sheet has a thickness of about 0.127 to about 1.14 mm.

29. The glass laminate of claim 17 wherein the ionomeric interlayer sheet has a first side and a second side, and wherein the first side is bonded directly to the glass sheet.

30. The glass laminate of claim 29 further comprising a film or a rigid sheet, and wherein said film or said rigid sheet is laminated to the second side of the ionomeric interlayer sheet.

31. The glass laminate of claim 30, wherein the film comprises a polymeric material comprising a polyester, polycarbonate, polyolefin, norbornene polymer, polystyrene, styrene-acrylate copolymer, acrylonitrile-styrene copolymer, polysulfone, polyamide, polyurethane, acrylic polymer, cellulose acetate, cellophane, vinyl chloride polymer, fluoropolymer, or combinations of two or more of these polymeric materials; or wherein the rigid sheet comprises glass, metal, ceramic, or a polymeric material comprising polycarbonate, acrylic, polyacrylate, cyclic polyolefin, metallocene-catalyzed polystyrene, a different material having a tensile modulus of about 690 MPa or higher as determined in accordance with ASTM D-638, or combinations of two or more of these materials.

32. The glass laminate of claim 30, wherein the rigid sheet is a second glass sheet, and said second glass sheet has a thickness of about 2 mm or more.

33. The glass laminate of claim 30, wherein the rigid sheet is a second glass sheet, and said second glass sheet has a thickness of about 1.5 mm or less.

34. The glass laminate of claim 17 wherein the nanofilled ionomer composition comprises
(1) an alkali metal ionomer that is an ionic, neutralized derivative of an ethylene carboxylic acid copolymer, wherein about 10% to about 35% of the total content of the carboxylic acid groups present in the precursor ethylene carboxylic acid copolymer are neutralized with alkali metal ions such as sodium, potassium or combinations thereof, and wherein the precursor ethylene carboxylic acid copolymer comprises copolymerized units of ethylene and about 20 to about 25 weight %, based on the total weight of the ethylene carboxylic acid copolymer, of copolymerized units of an α,β-ethylenically unsaturated carboxylic acid having 3 to 8 carbons; having a melt flow rate (MFR) of about 2.5 g/10 min or less;
(2) nanofiller; and
(3) a second ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising sodium cations, potassium cations or a combination thereof; and the second ionomer has a MFR from about 1 to about 20 g/10 min.

35. The glass laminate of claim 17 wherein the sheet comprising the nanofilled ionomer composition is a monolayer that consists essentially of the nanofilled ionomer composition.

36. The glass laminate of claim 17 wherein the sheet comprising the nanofilled ionomer composition is a multilayer sheet having two or more sub-layers, and wherein at least one of the sub-layers consists essentially of the nanofilled ionomer composition.

37. The glass laminate of claim 36 wherein each of the other sub-layers present in the multilayer sheet independently comprises a copolymer of an α-olefin and an α,β-ethylenically unsaturated carboxylic acid or ionomer thereof, poly(ethylene vinyl acetate), poly(vinyl acetal), polyurethane, polyvinylchloride, polyethylene, polyolefin block elastomer, silicone elastomer, epoxy resin, or combination of two or more thereof.

38. A process for preparing the glass laminate of claim 17 comprising: (i) providing an assembly comprising at least one glass layer and an ionomeric interlayer sheet comprising the nanofilled ionomer composition; and (ii) laminating the assembly to form the glass laminate, wherein the nanofilled ionomer composition is prepared by
(1) mixing the second ionomer with water heated to a temperature from about 80 to about 90° C. to provide a heated aqueous ionomer dispersion;
(2) optionally cooling the aqueous ionomer dispersion to ambient temperature;
(3) mixing the aqueous ionomer dispersion with the nanofiller to provide an aqueous dispersion of second ionomer and nanofiller;
(4) removing the water from the aqueous dispersion of ionomer and nanofiller to provide a mixture of water dispersable second ionomer and nanofiller in solid form; and
(5) melt blending the mixture of water dispersable ionomer and nanofiller with the first ionomer.

39. A process for preparing the glass laminate of claim 17 comprising: (i) providing an assembly comprising at least one glass layer and an ionomeric interlayer sheet comprising a nanofilled ionomer composition; and (ii) laminating the assembly to form the glass laminate, wherein the nanofilled ionomer composition is prepared by
(1) combining the second ionomer, water and the nanofiller in a high-shear melt-mixing process in a piece of equipment to form a melted mixture;
(2) continuing the high-shear melt-mixing until the nanoparticles are sufficiently comminuted or dispersed;
(3) optionally, removing some or all of the water from the melted mixture;
(4) optionally, repeating the addition and removal of water from the melted mixture;
(5) adding the first ionomer to the melted mixture to form the nanofilled ionomer composition; and
(6) removing the nanofilled ionomer composition from the piece of equipment.

40. The process of claim 39 wherein laminating the assembly comprises heating the pre-lamination assembly and applying vacuum, pressure or both.

41. The process of claim 39 wherein laminating the assembly comprises
(a) stacking the component layers of the glass laminate in the desired order to form a pre-lamination assembly;
(b) placing the assembly into a structure capable of sustaining a vacuum;
(c) drawing the air out of the vacuum structure to form a vacuum; and
(d) maintaining the vacuum and processing the pre-lamination assembly at a pressure of about 150 to about 250 psi, and at a temperature of about 110° C. to about 180° C.
